(19) United States
(12) Patent Application Publication
(10) Pub. No.: US 2009/0142537 A1
(43) Pub. Date: Jun. 4, 2009

(54) TRANSPARENT POLYCARBONATE BLEND

(75) Inventors: Sheng Hong, Berwyn, PA (US); Charles C. Zhou, Laurel, MD (US); Xianfeng Shen, King of Prussia, PA (US)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc, Philadelphia, PA (US)

(21) Appl. No.: 12/302,163

(22) PCT Filed: May 11, 2007
(86) PCT No.: PCT/US07/68747

§ 371 Date: Nov. 24, 2008

Related U.S. Application Data
(60) Provisional application No. 60/808,380, filed on May 25, 2006.

(51) Int. Cl. C08L 69/00; G11B 7/245

(52) U.S. Cl. 428/64.7; 525/148; 524/508

(57) ABSTRACT

The invention relates to a transparent thermoplastic blend of polycarbonate (PC) and a copolymer of methyl methacrylate (MMA) and naphthyl methacrylate or a substituted naphthyl methacrylate. This copolymer has excellent miscibility with polycarbonate resin, even at elevated temperature, producing transparent polycarbonate blends. The blend provides an improved scratch resistance of polycarbonate while maintaining its excellent optical properties.

### FIELD OF THE INVENTION

The present invention relates to a transparent thermoplastic blend of polycarbonate (PC) and a copolymer of methyl methacrylate (MMA) and naphthyl methacrylate or a substituted naphthyl methacrylate. This copolymer has excellent miscibility with polycarbonate resin, even at elevated temperature, producing transparent polycarbonate blends. The blend provides an improved scratch resistance of polycarbonate while maintaining its excellent optical properties.

### BACKGROUND OF THE INVENTION

Polycarbonate (PC) resin has good mechanical and thermal properties such as excellent resistance to impact, stiffness, transparency and dimensional stability at relatively high temperatures. These properties make polycarbonate useful in a variety of applications including glazing containers, glass lenses and medical devices.

One notable drawback of polycarbonate is its susceptibility to scratching. Poly(methyl methacrylate) (PMMA) has excellent scratch resistance and clarity, but it suffers from less dimensional stability, low impact strength and relatively poor thermal stability when compared to polycarbonate. Blends of PC and PMMA can produce the best properties of both materials. Although PMMA is considered to be compatible with polycarbonate, it normally is miscible only at low temperatures, and then separating at elevated temperatures. This results in a compounded article that is heterogeneous in nature and a final molded product that is opaque.

It is desirable to have a miscible and transparent blend of polycarbonate and polymethyl methacrylate. Transparent, single phase blends of PC and PMMA over a wide range of ratios are described in U.S. Pat. No. 4,743,654 and U.S. Pat. No. 4,745,029. The blend is formed by a solvent blending process, and the blend remains miscible at low temperatures.

U.S. Pat. No. 4,906,696 describes copolymers of methylmethacrylate and a carbocyclo methacrylate, such as phenyl methacrylate or cyclohexyl methacrylate. The polycarbonate/copolymer blends are described as clear and colorless at the test conditions used. However, at higher temperatures typically employed in industrial processing applications (280° C. and above) the copolymers separate from the polycarbonate forming a heterogeneous and opaque composition, especially in blends having higher levels of the copolymer. Thus, such copolymers are not particularly useful and cannot provide the above-mentioned benefits. While the '696 application lists naphthyl methacrylate as a usable monomer for the copolymer, the surprising advantage of copolymers formed from this monomer in producing a clear blend at high processing temperatures was not recognized.

Surprisingly it has now been found that a stable, homogeneous, transparent blend of polycarbonate and a methyl methacrylate/naphthyl methacrylate can be produced which does not phase separate at 280° C.

### SUMMARY OF THE INVENTION

The invention relates to a thermoplastic homogeneous blend comprising:
a) 10 to 99.5 weight percent of polycarbonate; and
b) 0.5 to 90 weight percent of a copolymer comprising:
   1) 5-98 weight percent of methyl methacrylate units; and
2) 2 to 95 weight percent of naphtyl (meth)acrylate units and/or substituted naphtyl (meth)acrylate units,
   wherein said composition does not phase separate at 280° C.

### BRIEF SUMMARY OF THE DRAWINGS

FIG. 1. Shows the appearance of compound bars of Example 3 made from polycarbonate 1 (PC-1, melt flow ˜11, GE Lexan® 141) and poly(methyl methacrylate) or its copolymers

FIG. 2. Shows the appearance of polymer blend made from PC-1 (melt flow ˜11) and poly(2-napthyl methacrylate) (Example 6)

FIG. 3. Compares the appearance of compound bars made from PC-1 (melt flow ˜11) and copolymers of methyl methacrylate and phenyl methacrylate or 2-Naphthyl methacrylate.

### DETAILED DESCRIPTION OF THE INVENTION

The present invention relates to a transparent thermoplastic blend of polycarbonate (PC) and a copolymer of methyl methacrylate (MMA) and naphthyl methacrylate (NpMA).

The term “polycarbonate (PC)” denotes a polyester of carbonic acid, that is to say a polymer obtained by the reaction of at least one carbonic acid derivative with at least one aromatic or aliphatic diol. The preferred aromatic diol is bisphenol A, which reacts with phosgene or else, by transesterification, with ethyl carbonate. It can be homopolycarbonate or copolycarbonate based on a bisphenol of formula HO-Z-OH for which Z denotes a divalent organic radical which has from 6 to 30 carbon atoms and which comprises one or more aromatic group(s). As examples, the diphenol can be:
dihydroxybiphenyls,
bis(hydroxyphenyl)alkanes,
bis(hydroxyphenyl)cycloalkanes,
indanebisphenols,
bis(hydroxyphenyl)ethers,
bis(hydroxyphenyl) ketones,
bis(hydroxyphenyl) sulphones,
bis(hydroxyphenyl) sulphoxides,
α,α′-bis(hydroxyphenyl)diisopropylbenzenes.
   It can also relate to derivatives of these compounds obtained by alkylation or halogenation of the aromatic ring. Mention will more particularly be made, among the compounds of formula HO-Z-OH, of the following compounds:
hydroquinone,
resorcinol,
4,4′-dihydroxybiphenyl,
bis(4-hydroxyphenyl) sulphone,
bis(3,5-dimethyl-4-hydroxyphenyl)methane,
bis(3,5-dimethyl-4-hydroxyphenyl) sulphone,
1,1-bis(3,5-dimethyl-4-hydroxyphenyl)-para/meta-isopropylbenzene,
1,1-bis(4-hydroxyphenyl)-1-phenylethane,
1,1-bis(3,5-dimethyl-4-hydroxyphenyl)cyclohexane,
1,1-bis(4-hydroxyphenyl)-3-methylcyclohexane,
1,1-bis(4-hydroxyphenyl)-3,3-dimethylcyclohexane,
1,1-bis(4-hydroxyphenyl)-4-methylcyclohexane,
1,1-bis(4-hydroxyphenyl)cyclohexane,
1,1-bis(4-hydroxyphenyl)-3,3,5-trimethylcyclohexane,
2,2-bis(3,5-dichloro-4-hydroxyphenyl)propane,
2,2-bis(3-methyl-4-hydroxyphenyl)propane,
2,2-bis(3,5-dimethyl-4-hydroxyphenyl)propane,
2,2-bis(4-hydroxyphenyl)propane (or bisphenol A),
2,2-bis(3-chloro-4-hydroxyphenyl)propane,
2,2-bis(3,5-dibromo-4-hydroxyphenyl)propane,
2,4-bis(4-hydroxyphenyl)-2-methylbutane,
2,4-bis(3,5-dimethyl-4-hydroxyphenyl)-2-methylbutane,
α,α′-bis(4-hydroxyphenyl)-o-diisopropylbenzene,
α,α′-bis(4-hydroxyphenyl)-m-diisopropylbenzene (or bisphenol M).

The preferred polycarbonates are the homopolycarbonates based on bisphenol A or 1,1-bis(4-hydroxyphenyl)-3,3,5-trimethylcyclohexane and the copolycarbonates based on bisphenol A and 1,1-bis(4-hydroxyphenyl)-3,3,5-trimethylcyclohexane. The polycarbonate generally has a weight average molecular weight of 10,000 to 200,000.

The copolymer has the structural formula:

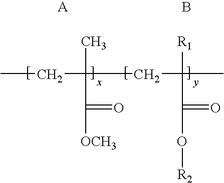

where x and y are integers calculated to result in a content of PMMA in the copolymer in the range of 5 to 98 weight percent and where R₁ denotes —CH₃ or H and R₂ is a naphthyl and/or substituted naphthyl group.

The naphthyl or substituted naphthyl (meth)acrylate is present in the copolymer at from 2 to 95 weight percent, and preferably from 10 to 70 weight percent, with the methyl methacrylate at 5 to 98, and preferably 30-90 weight percent. This would also apply to a mixture of naphthyl and substituted napthyl (meth)acrylate monomer units. The (meth)acrylate designation is meant to include both the acrylate, the methacrylate, and mixtures thereof. Examples of substituted naphthyl groups useful in the invention include, but are not limited to, alkyl and aryl side groups, and functional groups such as carboxyls, OH, and halides.

In addition to the methyl methacrylate and napthyl (meth)acrylate, up to 40 weight percent of the copolymer can be one or more other ethylenically unsaturated monomer units that are copolymerizable with the methyl methacrylate and napthyl (meth)acrylate. The term “copolymer” as used herein is intended to include both polymers made from two monomers, as well as polymers containing three or more different monomers. Preferred termonomers include acrylates, methacrylates and styrenic, including but not limited to linear, or branched C₁₋₁₂ alkyl and aryl (meth)acrylates, styrene and alpha-methyl styrene.

The polymethyl methacrylate copolymer may be produced by free radical polymerization, using techniques known in the art. A preferred method of polymerization is a bulk free radical polymerization or in an organic solvent, producing a viscous polymer solution. The polymer could also be made by emulsion, inverse emulsion and suspension polymerization, as a batch polymerization or with delayed feeds.

The copolymer has a weight-averaged molecular weight in the range of 5,000 g/mol to 4,000,000 g/mol, and preferably 50,000 to 2,000,000 g/mol.

The copolymer of the invention is blended with polycarbonate at from 10 to 99.5, and preferably from 50 to 99 weight percent of polycarbonate with 0.5 to 90, and preferably from 1 to 50 weight percent of the copolymer. At low levels of copolymer, the copolymer primarily acts as a process aid. In addition to the copolymer and polycarbonate, other common additives may also be blended into the composition. The additives could include, but are not limited to pigments, dyes, plasticizers, antioxidants, heat stabilizers, UV stabilizers, processing additives or lubricants, inorganic particles, cross-linked organic particles, and impact modifiers. In one embodiment, the copolymer is used as a dried pellet or powder and is blended with polycarbonate pellets along with any other additives to form a polycarbonate composite through melt compounding and extrusion.

The polycarbonate/copolymer blend or composite of the invention stays miscible up to at least 320° C. This results in a clear composition, even under high temperature processing conditions. This same high-heat homogeneous behavior is not seen with other methyl methacrylate/aryl methacrylate copolymers, such as with benzyl methacrylate phenyl methacrylate and cyclohexyl alkyl methacrylates.

The polycarbonate/copolymer blend or composite of the invention can be used to form articles, and especially transparent articles by means known in the art, including, but not limited to melt extrusion, injection molding, thermoforming, blown films, fiber spinning, and blow molding.

Some of the useful articles that can be formed from the blend of the invention include, but are not limited to transparent films, optical discs such as DVDs and CDs, sheet, rods, pellets, films for use as an outer layer in a flat panel display or LED, membrane switches, decals or transfer films, instrument panels, smart cards, glazing containers, glass lenses and medical devices

In one embodiment, the polycarbonate/copolymer blend is melt compounded by extrusion, then injection molded directly into articles, or into sheets, films, profiles, or pellets that can be further processed into articles.

### EXAMPLES

### Example 1

### Synthesis of Copolymer of MMA and NpMA

Methyl methacrylate (MMA) and naphthyl methacrylate (NpMA) were dissolved in toluene. The amount of naphthyl methacrylate is calculated to yield the random copolymers having 80 to 95 wt % of PMMA. Polymerization was initiated with about 0.5% of AIBN. The polymerizations were carried out at 70° C. with stirring. In a similar manner, a copolymer of PMMA with 30 weight percent of phenyl methacrylate was synthesized as a Comparative example.

### Example 2

### Characterization of the Copolymers

The resulting copolymers were isolated by precipitation into methanol, and dried in a vacuum oven at 80° C., and then characterized by ¹H NMR and by DSC cycling from −50 to 175° C. at 20° C./min. The resulting copolymers have glass transition temperatures that are higher than that of PMMA (=105° C.).

TABLE 1
Tg of copolymer of methyl methacrylate
and naphthyl methacrylate.

| MMA content | Tg |
|---|---|
| (mol %) | (° C.) |
| 95 | — |
| 90 | — |
| 80 | 124 |

### Example 3

### Compounding Polycarbonate with the Copolymers

The copolymers of Example 2 were compounded with PC-1 at 280° C. followed by injection molding with Nozzle temperature at 310° C. and mold temperature at 140° C.

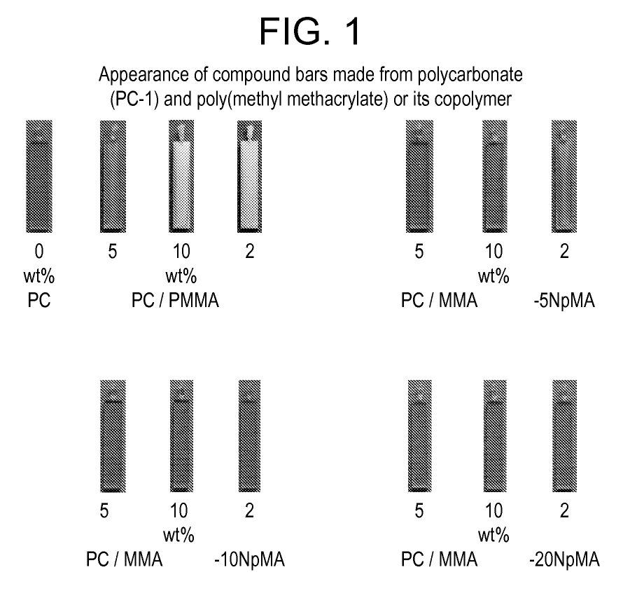

The appearances of these compound bars are shown in FIG. 1. MMA-20NpMA denotes a copolymer of methyl methacrylate and naphthyl methacrylate (NpMA) which containing 20 wt % of NpMA whereas PC-1/MMA-20NpMA denotes a blend of PC-1 and MMA-20NpMA. The weight percent indicated below the compound bar is the amount of copolymer in the blend. Comparative examples containing PC-1 and homo PMMA were prepared by the same procedure. A summary of the physical appearance of pure PMMA (comparative), MMA/PhMA copolymer (comparative) and MMA/NpMA copolymer of the invention are shown in Table 1.

TABLE 1
Summary of results

| Experiment | Blend with PC-1 | Appearance |
|---|---|---|
| 1 | 5% PMMA | Translucent |
| 2 | 10% PMMA | Opaque |
| 3 | 20% PMMA | Opaque |
| 4 | 5% Poly(MMA-co-30% PhMA) | Clear |
| 5 | 10% Poly(MMA-co-30% PhMA) | Translucent |
| 6 | 20% Poly(MMA-co-30% PhMA) | Opaque |
| 7 | 5% Poly(MMA-co-10% NpMA) | Clear |
| 8 | 10% Poly(MMA-co-10% NpMA) | Clear |
| 9 | 20% Poly(MMA-co-10% NpMA) | Clear |

### Example 4

### DSC Analysis Results

The compound samples of PC-1 and MMA-20NpMA in present invention were also examined by DSC. When the loading of MMA-20NpMA increases from 5 to 10, and then 20 wt %, the Tg of compound decreases from 148 to 146 and then 140° C. (see Table 2). The observation of a single glass transition temperature also supported the optical observation that a homogeneous miscible blend was formed.

TABLE 2
Tg of polycarbonate compounds containing copolymer
of methyl methacrylate and naphthyl methacrylate.

| PC-1 | Tg |
|---|---|
| (wt %) | (° C.) |
| 100 | 149 |
| 95 | 148 |
| 90 | 146 |
| 80 | 140 |

### Example 5

### Synthesis of Homopolymer of 2-naphthyl Methacrylate

Naphthyl methacrylate (NpMA) was dissolved in toluene. Polymerization was initiated with about 0.5% of AIBN. The polymerizations were carried out at 70° C. with stirring until a viscous solution was obtained.

### Example 6

### Compounding Polycarbonate with the Homopolymers of 2-naphthyl Methacrylate

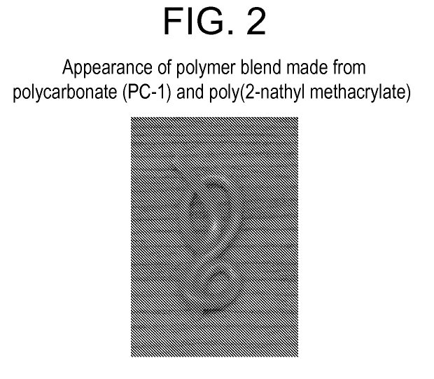

The homopolymer of 2-naphthyl methacrylate was compounded with PC-1 at 280° C. followed by injection molding with Nozzle temperature at 310° C. and mold temperature at 140° C. The polymer blends were opaque as collected (shown in FIG. 2).

### Example 7

### Comparative Examples

Other MMA/aryl methacrylate polymers were made in a manner similar to that of Example 1, and compounded with polycarbonate as described in Example 3. The aryl methacrylate comonomers sed were represented by the formulas:

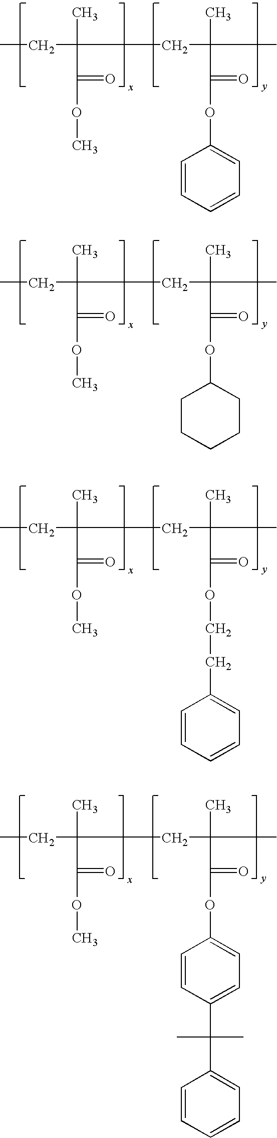

For all those copolymers, compounding experiments with polycarbonate resins (up to 20 wt % loading of such copolymers) did not produce transparent polycarbonate blends under normal polycarbonate processing conditions.

### Example 8

### Synthesis of Copolymers of MMA and PhMA (Comparative)

Methyl methacrylate (MMA) and phenyl methacrylate (PhMA) were dissolved in toluene. The amount of phenyl methacrylate is calculated to yield the random copolymers having 6 wt %, 9 wt %, 11 wt %, and 13 wt % of phenyl methacrylate, respectively. Polymerization was initiated with about 1%, 0.5%, 0.25%, and 0.125% of AIBN, a free radical initiator, respectively. The polymerizations were carried out at 70° C. with stirring until a viscous solution was obtained. Polymers were collected after the precipitation into methanol solution.

### Example 9

### Synthesis of Copolyners of MMA and 2-NpMA

Methyl methacrylate (MMA) and 2-naphthyl methacrylate (NpMA) were dissolved in toluene. The amount of 2-naphthyl methacrylate is calculated to yield the random copolymers having 6 wt %, 9 wt %, 11 wt %, and 13 wt % of 2-naphthyl methacrylate, respectively. Polymerization was initiated with about 1%, 0.5%, 0.25%, and 0.125% of AIBN, a free radical initiator, respectively. The polymerizations were carried out from 25 to 70° C. with stirring until a viscous solution was obtained. Polymers were collected after the precipitation into the methanol solution. Polymers were collected after the precipitation into methanol solution.

### Example 10

### Compounding Polycarbonate with the Copolymers

The copolymers of Examples 8 and 9 were compounded (50/50 blends) with PC-1 at 280° C. followed by injection molding with Nozzle temperature at 310° C. and mold temperature at 140° C.

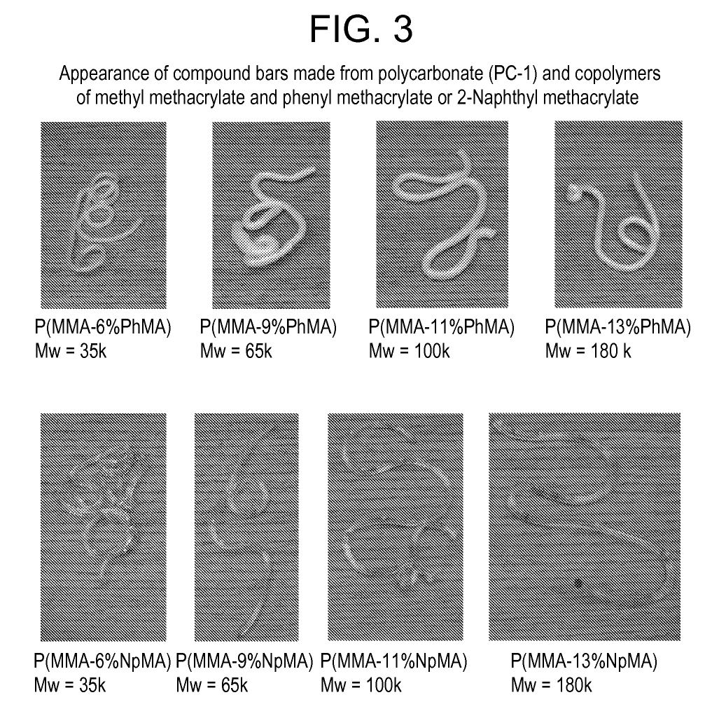

The appearances of these compound bars are given in FIG. 3. The results are summarized in Table 3.

Clearly, 2-naphthyl methacrylate is superior to phenyl methacrylate as a comonomer with methyl methacrylate to improve the miscibility (transparency) with polycarbonate.

TABLE 3
Summary of results

| Experi- | | Initiator | |
|---|---|---|---|
| ment | Blend with Polycarbonate 1 | Level | Appearance |
| 1 | 50% Poly(MMA-co-6% PhMA) | 1% | Opaque |
| 2 | 50% Poly(MMA-co-9% PhMA) | 0.5% | Opaque |
| 3 | 50% Poly(MMA-co-11% PhMA) | 0.25% | Opaque |
| 4 | 50% Poly(MMA-co-13% PhMA) | 0.125% | Opaque |
| 5 | 50% Poly(MMA-co-6% NpMA) | 1% | Clear |
| 6 | 50% Poly(MMA-co-9% NpMA) | 0.5% | Clear |
| 7 | 50% Poly(MMA-co-11% NpMA) | 0.25% | Clear |
| 8 | 50% Poly(MMA-co-13% NpMA) | 0.125% | Clear |

### Example 11

### Compounding with Polycarbonate of Different Melt Flow

The copolymers of Examples 9 were compounded (50/50 blends) with PC-2 (melt flow ˜4) at 280° C. followed by injection molding with Nozzle temperature at 310° C. and mold temperature at 140° C. The results are summarized in Table 4.

TABLE 4
Summary of results

| Experiment | Blend with PC-2 | Appearance |
|---|---|---|
| 1 | 50% Poly(MMA-co-6% NpMA) | Clear |
| 2 | 50% Poly(MMA-co-9% NpMA) | Clear |
| 3 | 50% Poly(MMA-co-11% NpMA) | Clear |
| 4 | 50% Poly(MMA-co-13% NpMA) | Clear |

### Example 12

### Cloud Point

Cloud point measurement quantifies the upper temperature for a given blend to maintain a single phase. Cloud points of PC-1 blends with PMMA copolymers containing 2-napthylmethacrylate and phenylmethacrylate are compared in Table 5. The results correspond to the upper temperature when the blend turns cloudy. The result indicated that 2-napthylmethacrylate is superior to phenylmethacrylate in maintaining the transparency of the polycarbonate matrix at elevated temperature.

TABLE 5
Cloud point measurement

| | Cloud Point (° C.) | |
|---|---|---|
| | 5 wt % in PC-1 | 20 wt % in PC-1 |
| PMMA | <250 | <250 |
| P(MMA-co-35 wt % PhMA) | 280 | 260 |
| P(MMA-co-35 wt % NpMA) | >325 | >325 |

What is claimed is:

1. A thermoplastic homogeneous blend comprising:
a) 10 to 99.5 weight percent of polycarbonate; and
b) 0.5 to 90 weight percent of a copolymer comprising:
i) 5-98 weight percent of methyl methacrylate units; and
ii) 2 to 95 weight percent of naphtyl (meth)acrylate units and/or substituted naphtyl (meth)acrylate units,
wherein said composition does not phase separate at 280° C.

2. The thermoplastic blend of claim 1 comprising:
a) 50 to 99 weight percent of polycarbonate; and
b) 1 to 50 weight percent of said copolymer.

3. The thermoplastic blend of claim 1 wherein said copolymer comprises:
1) 30-90 weight percent of methyl methacrylate units; and
2) 10 to 70 weight percent of naphtyl methacrylate units and/or substituted naphtyl methacrylate units.

4. The thermoplastic blend of claim 1 wherein said copolymer further comprises up to 40 weight percent one or more ethylenically unsaturated monomer units copolymerizable with said methyl methacrylate and substituted naphtyl methacrylate monomer units.

5. The thermoplastic blend of claim 4, wherein said ethylenically unsaturated monomer units are one or more monomers selected from the group consisting of acrylates, methacrylates and styrenics.

6. The thermoplastic blend of claim 5, wherein said ethylenically unsaturated monomer units are selected from C₁₋₁₂ alkyl acrylates and C₁₋₁₂ alkyl methacrylates.

7. The thermoplastic blend of claim 1 further comprising one or more additives selected from the group consisting of pigments, dyes, plasticizers, antioxidants, heat stabilizers, UV stabilizers, processing additives or lubricants, inorganic particles, cross-linked organic particles, and impact modifiers.

8. An article comprising a thermoplastic homogeneous blend comprising:
a) 10 to 99.5 weight percent of polycarbonate; and
b) 0.5 to 90 weight percent of a copolymer comprising:
i) 5-98 weight percent of methyl methacrylate units; and
ii) 2 to 95 weight percent of naphtyl (meth)acrylate units and/or substituted naphtyl (meth)acrylate units,
wherein said composition does not phase separate at 280° C.

9. The article of claim 8 comprising a transparent film, optical disc such as a DVD or CD, a sheet, rods, pellets, films for use as an outer layer in a flat panel display or LED, membrane switches, decals or transfer films, instrument panels, smart cards, glazing containers, glass lenses or medical devices.
